(19) United States
(12) Patent Application Publication
(10) Pub. No.: US 2008/0040438 A1
(43) Pub. Date: Feb. 14, 2008

(54) Device and Method of Sending and Receiving a Message

(76) Inventors: Yi Min Gan, Beijing (CN); Ling Jin, Beijing (CN); Qing Tao Sun, Beijing (CN); Zhe Xiang, Beijing (CN)

Correspondence Address: IBM CORPORATION;INTELLECTUAL PROPERTY LAW, 11400 BURNET ROAD, AUSTIN, TX, 78758, US

(21) Appl. No.: 11/834,777

(22) Filed: Aug. 7, 2007

(30) Foreign Application Priority Data
Aug. 8, 2006 (CN) 200610151461.4

(51) Int. Cl. G06F 15/16

(52) U.S. Cl. 709/206

(57) ABSTRACT

Provided are message sending and receiving devices and methods for distributed authentication as to whether a received message is sent by a service registered with a service provider. Among the devices and methods, the message receiving device receives a message of service sent by a message sending device and provided by a service provider; and according to the information of services registered with the service providers stored locally, authenticates whether or not the message is sent by a service registered with the service provider and stored locally; the message sending device receives a service message sent by a service provider to a message receiving device; sends the message of service to the message receiving device; and sends the information of services registered with service providers by the message receiving device to the message receiving device.

### TECHNICAL FIELD

The present invention relates in general to information authentication technology fields. Specifically, the present invention relates to a device and method of sending and receiving a message.

### BACKGROUND ART

Message based service is becoming increasingly popular in recent years, and there have been a lot of commercial platforms which provide message based services. These service providers provide a wide range of contents based services to the receiving end users, thus it is sometimes also known as content providers. These contents are sent to the registered or subscribed receiving end users in format of message through telecommunications operator platforms, these messages including weather forecast, news, stock information, etc. This business model has now become a new business model, in which telecommunications operators and service providers share profits, and has become a new growth point of profits for telecommunications services.

However, in order to earn more profits, some service providers do not comply with the rules of this business model, and take fraudulent means to send message to those who have not registered or subscribed its services and request these users to pay for the services. The original operation platform of telecommunication operators can not authenticate whether the messages sent by service providers to the end users are registered or subscribed service messages, which cause receiving end users to often receive this type of fraud service, including SMS and MMS. This makes a serious impact on the image of telecommunications operators to users, resulting in the loss of customers. Therefore, telecommunications operators have started to build this kind of authentication platform, and will store receiving end users' registration information in the operating platform of telecommunications operators and will authenticate each message of service from the service provides to ensure that end users who receive the message have indeed registered or subscribed the services.

In particular, with the popularization of services of message, message authentication has become a great burden for telecommunications operators, and they now buy a large number of servers working as authentication server to support this kind of services of message authentication. However, how many servers should be bought by telecommunications operators is also a problem. Because most of the time, the message number is stable, and authentication server number can be obtained through calculation. But in short term, there will be a large number of messages which need to be authenticated. For example, it may hail, then weather emergency service providers need to send a large quantity of messages of service to end users registering to receive this kind of message in a very short time. Therefore, this centralized authentication solutions will increase the cost of telecommunications operation; on the other hand, When a large number of messages of service need to be sent in a short term, high-load operation of telecommunications authentication platform may lead to authentication server down.

Similar problems to when the fraud message is received exist in other areas; for example, in mail system, there is the problem a mail which is not intended to be received is received. In the current mail system, lists of black- and white-name are used to solve the sender authentication problem, in which client users can define a white name list and a black name list, and if the name of the sender in the mail is on the white name list, the mail is received; while if the sender's name is on a black name mail list, the mail is discarded. This is a typical distributed authentication. However, there are a lot of problems when the solution is applied to the interactive platform between telecommunications operators and receiving end users. First, the message receiving means based on services of message does not record registered service of message, and a fraud message is usually found after the users receive it, that is, the client has neither an authentication related message, nor the capability to authenticate a message, while the billing system has charged the fee of the message. Thus, the solution can not be applied to authentication of telecommunication fraud messages.

### SUMMARY OF INVENTION

Therefore, in order to prevent service providers from sending end users fraud messages and reduce the operating costs of telecommunications at the same time, and make short-term, high-volume messages not affect the operation of telecommunications platform, there is a need for a distributed message authentication solution which is able to:

(1) authenticate the messages from the service providers to the message receiving devices by the message receiving devices to determine whether the messages are of services registered by the message receiving devices;

(2) authenticate the messages at the message receiving device side to reduce telecommunication operation costs;

(3) authenticate the messages at the message receiving device side so that the short-term, high-volume messages will not affect the operation of the telecommunications platform.

According to one aspect of the invention, there is provided a message receiving device, comprising:

storage means for storing information of services registered by the message receiving device with service providers, wherein the information of services comes from a message sending device;

first receiving means for receiving a message of service sent by the message sending device and provided by the service provider; and

authenticating means for, according to the information of services registered with the service providers stored in the storage means, authenticating whether or not the message is sent by a service registered with the service providers stored in the storage means.

According to another aspect of the invention, there is provided a message sending device, comprising:

first receiving means for receiving a service message sent by a service provider to a message receiving device;

first sending means for sending the service message to the message receiving device;

second sending means for sending the information of services registered with service providers by the message receiving device to the message receiving device.

According to further aspect of the invention, there is provided a message receiving method, comprising:

receiving a message of service sent by a message sending device and provided by a service provider; and

according to information of services registered with the service providers stored locally, authenticating whether or not the message is sent by a service registered with the service providers stored locally.

According to still further aspect of the invention, there is provided a message sending method, comprising:

receiving a message of service sent by a service provider to a message receiving device;

sending the message of service to the message receiving device;

sending the information of services registered with service providers by the message receiving device to the message receiving device.

According to a yet further aspect of the invention, there is provided a computer program product, comprising computer program code for implementing the method described in the specification and medium for storing the program code.

### BRIEF DESCRIPTION OF THE DRAWINGS

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

FIG. 1 illustrates the centralized authentication process of a message of service in the prior art;

FIG. 2 illustrates a distributed authentication process according to one preferred embodiment of the present invention;

FIG. 3 illustrates another distributed authentication process according to one preferred embodiment of the present invention

FIG. 4 illustrates the composition of the message sending device and the message receiving device according to one preferred embodiment of the present invention.

### DETAILED DESCRIPTION OF THE PREFERRED EMBODIMENTS

Preferred embodiments of the present invention will now be described more fully hereinafter below in more detail with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

Now refer to FIG. 1, which illustrates the centralized authentication process of a message of service. In the process, the message receiving device is the message receiver, that is, the client (hereinafter the terms “user”, “client”, “message receiving device”, “message receiving terminal” denote the same meaning), which implement the entire message receiving process through registering the service provided by the service provider with the message sending device of telecommunications, and then obtaining the message of service. As the recipient of message, users receive messages with message receiving devices including mobile phones and other message receiving devices. The received message categories for example include short messages and multi-media messages, etc. A message sending device of telecommunications comprises a message gateway, a registration server and a registration database, which are not shown in FIG. 1, to support a centralized authentication for a message. Among the message sending devices, the message gateway receives the registration message from the message receiving device, parses the message, and then sends parsed registration information to the registration server. The registration server, connected to a registration database server, sends the registration information to a registration database in order to store the service registered by the message receiving devices with the service providers. All these components, as a whole, comprise the message sending device of telecommunications shown in FIG. 1. In the process of operating the entire system, two sub-process are included, e.g. the registration stage and usage stage.

In the registration stage, the message receiving device first sends registration message (S101). Generally, telecommunications will name or number their service providers, and also number the various services provided by the service providers to facilitate the message receiving devices to register the services. For example, if a message receiving device will register a No. 123 weather forecasting service which is provided by the No. 888 service provider, the message receiving device can send message 888123 to the message sending device of telecommunication. The sending device of telecommunication finds that the message is a registered message after parsing it by its message gateway, and then sends the identification of the message receiving device (such as mobile phone number and other device identification, etc), the registered service provider 888 and registered service 123 as registration information to the registration server. The registration server will save all this information into the registration service information center (S102), and then the registration is successful. Next, the message sending device of telecommunication sends the registration information to service provider (S104) to facilitate the service provider to provide the service to the message receiving device on time. Also the message sending device of telecommunication will return the message of registration success to the message receiving device through the message gateway (S103). Step S103 and Step S104 do not need follow specific execution sequence, any step can run first. Thus, the registration stage is ended. It can be understood that the message receiving device does not save the registration information. Even it saves the sent registration message; there is no component in it which can be used to save the registration information for authenticating the received message.

In the usage stage, the service providers first provide the services to the message receiving device based on received message of service registered by the message receiving device, and send the service message to the message sending device of telecommunication (S105). The message sending device of telecommunication authenticates whether or not the message sent by the service provider to the message receiving device is sent by a service registered by the message receiving device according to the information of services registered with the service providers stored locally (S106). If the message is sent by the service registered with the service providers, the message sending device of telecommunication sends the message to the message receiving device through the message gateway (S107), then the message receiving device will receive the message of service provided by the service provider successfully. If the authentication is failed, it is believed that the message is fraudulent, and the message sending device of telecommunication will discard this message (S108) and will not send it to the message receiving device. Meanwhile, the billing system of telecommunication will not charge this message. Thus, the usage stage of authentication of message is ended.

According to the distributed authentication method disclosed in the present invention, the message authentication is executed in the message receiving device side. The message sending device of telecommunication is not directly involved in the authentication process, but provides the information for authenticating, and receives authentication results, then decides whether or not to charge the message according to the authentication results of the message receiving device. Here, the information for authentication is the base for the message receiving device to authenticating the message, i.e., the information for authentication is from registration information of service registered with the service provider by the message receiving device. Receiving the information for authenticating by the message receiving device can take place either in the registration phase or in the usage stage.

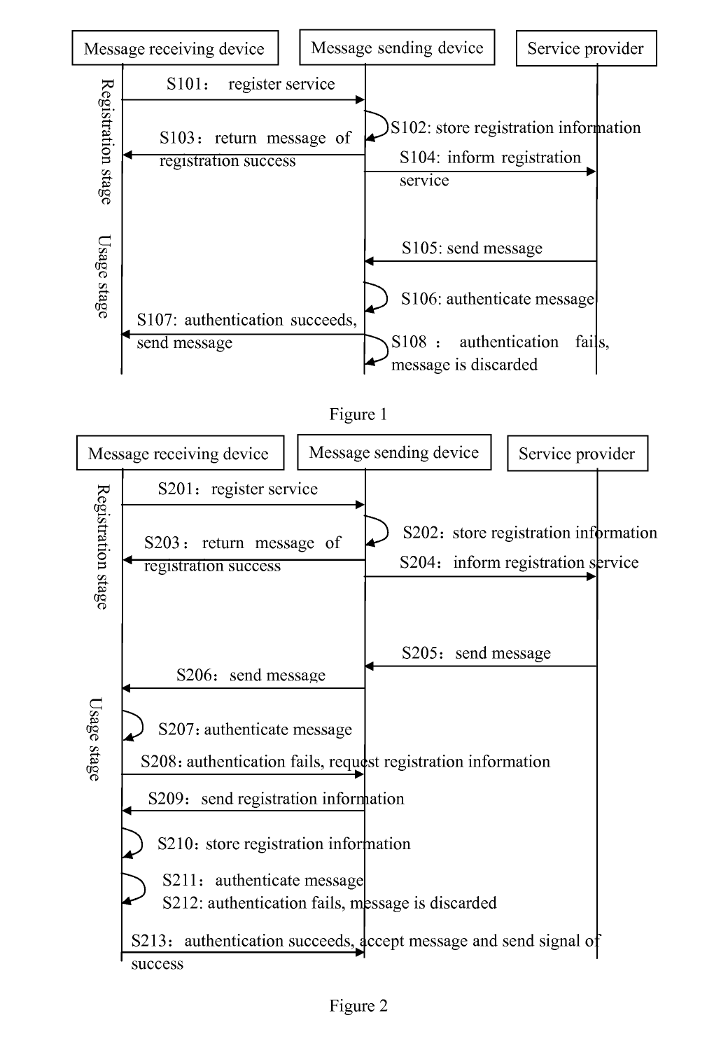

Refer to FIG. 2, which illustrates a distributed authentication process according to one preferred embodiment of the present invention. In this process, it is during the usage stage that message receiving device receives information for authentication. The steps S201-S204 in registration stage are the same with the steps S101-S104 in FIG. 1, which will not be described here. However, here the message sending device of telecommunications is not limited to the existing implementation of message sending device of telecommunications, that is, not limited to the implementation of message sending function of telecommunication by using message gateway, registration server and registration database; other ways can be used, for example, database is not used to store registration information; instead, a storage means is used to store registration information, and other device is used to interact with the storage means, etc.

During the usage stage, service provider first sends the message of service to the message sending device of telecommunication (S205), and message sending device of telecommunication does not check and authenticate the message, and sends it to message receiving device directly (S206). The message receiving device comprises storage means for storing information of services registered by a message receiving device with service providers, and authenticating means for, according to the information of services registered with the service providers stored in the storage means, authenticating whether or not the message is sent by a registered service with the service providers stored in the storage means (S207). If authentication succeeds, the message receiving device accepts the message and sends a signal indicating that the message is successfully received to the message sending device, then the message sending device of telecommunication can charge this message. If the authentication fails, it is possible for the message receiving device to have information of service registered with the service providers but the information is not stored in the storage means, and the message receiving device will send request for the current information of service registered with the service providers (S208). The message receiving device can either request the total information of services registered with the service providers to replace the total information of services registered with the service providers stored in the storage means or just request the information of services registered with the service providers to replace the information of services registered with the service providers but not stored in the storage means. After receiving this request, the message sending device of telecommunication will send the total information of services registered with the service providers or part information of services registered with the service providers but not stored in the storage means to the message receiving device in response to the request (S209). If the database is used to store the information of services registered with the service providers on both the message receiving device and message sending device of telecommunication, database synchronization technology can be used here to make the stored information of services registered with the service providers both on the message receiving device and on the message sending device consistent. In this way, the message receiving device, based on the latest total information of service registered with service providers, may re-authenticate whether or not the message is of a service registered by the message receiving device with the service providers (S211). Also, if the authentication succeeds, the process proceeds to step S213, where the message receiving device accepts the message and sends the signal indicating that the message is successfully received to the message sending device, and then the message sending device of telecommunication can charge this message. If the authentication fails, besides discarding this message, the message receiving device sends to the message sending device a signal informing that no charge has to done for this message due to an authentication failure. The signal might not be sent for example, because each message has its own life cycle, and time out, and the message sending device will discard the message automatically if it has not received the signal indicating that the message is successfully sent, and no fee will be charged for this message in this situation. Another feature of this distributed authentication is when the message receiving device requests the message sending device of telecommunication for information of services registered with the service providers, the message sending device of telecommunication can send the total information of services registered with the service providers stored on it to the message receiving device in one transaction.

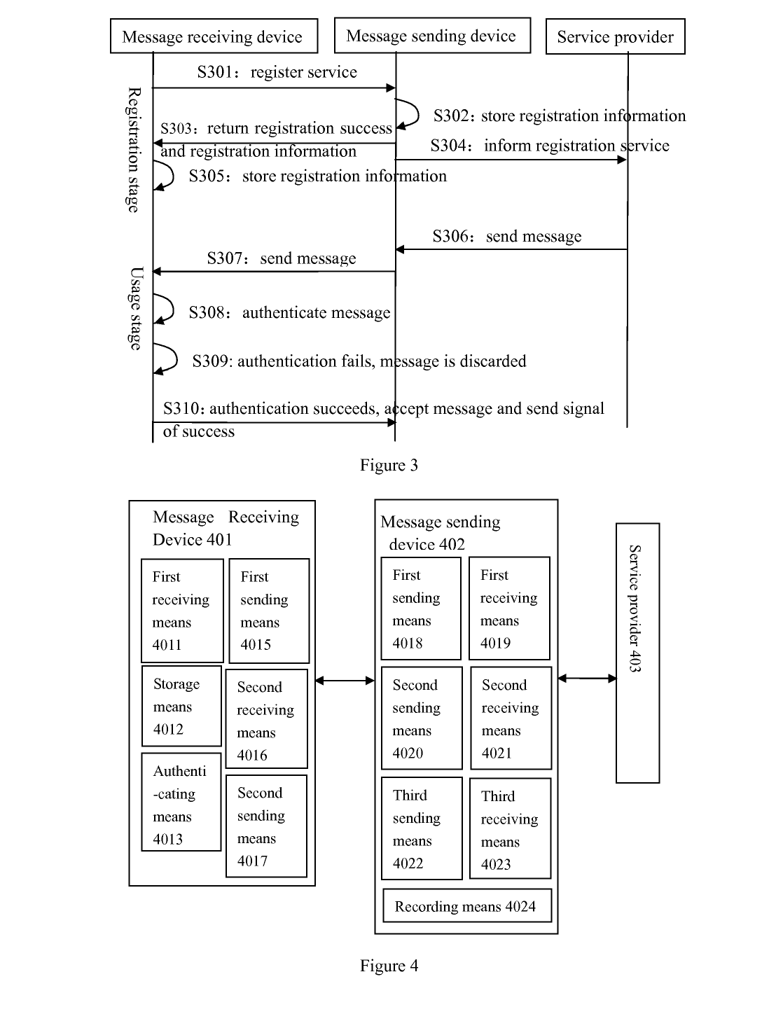

In another embodiment, it is during registration stage that message receiving device receives information for authentication, referring to FIG. 3. During the registration stage, steps S301-S304 are substantially same with the steps S101-S104 in FIG. 1, but in step S303, besides the message of registration success, the information of registered service is also returned. All these returned registered information will be received and then will be stored in step S305. Step S304 and Step S303, step S304 and step S305 have no specific execution sequences, because the objects pointed by these steps are different, one is pointing to the user, and another is pointing to the service provider. However, step S303 and step S305 have specific execution sequences. Accordingly, when the message receiving device registers a service with a service provider, the message receiving device will store the information of services provided by this service provider; thus, it is not necessary for the message receiving device to access the server to update the information of services provided by the service provider stored on the message receiving device every time authentication fails. During the registration stage in this embodiment, message synchronization between the message receiving device and the message sending device of telecommunication can be implemented by using database synchronization technology, or other network interaction mode, such as message mode with the addition of a parser module to the message receiving device.

During the usage stage, the service provider first sends the message to the message sending device of telecommunication (S306). The message sending device does not check and authenticate the message, and sends it to message receiving device directly (S307). After the message receiving device parses the received message, and gets information of services registered by a message receiving device with service providers. The message receiving device comprises storage means for storing information of services registered by a message receiving device with service providers during the registration stage; and authenticating means for, according to the information of services registered with the service providers stored in the storage means, authenticating whether or not the message is sent by a service registered with the service providers stored in the storage means (S308). If authentication succeeds, the message receiving device sends the signal indicating that message is successfully received to the message sending device, and then the message sending device of telecommunication can charge this message. If the authentication fails, besides discarding this message (S309), the message receiving device can send the message sending device a signal informing that no charge has to be done for this message due to authentication failure. The signal may not be sent for example, because each message has its own life cycle, and when timed out, the message sending device will discard the message automatically if it has not received the signal indicating that message is successfully sent, and no fee will be charged for this message in this situation.

Two working processes for distributed message authentication are described hereinbefore, and it should be understood that those two processes can be implemented by the same system hardware. FIG. 4 illustrates the composition of the message sending device and the message receiving device according to one preferred embodiment of the present invention. The message receiving device 401, the message sending device of telecommunication 402 and the service provider 403 are shown in FIG. 4. The message receiving device 401 comprises storage means 4012 for storing information of services registered by the message receiving device 401 with service providers from a message sending device; first receiving means 4011 for receiving a service message sent by the message sending device 402 and provided by the service provider; and authenticating means 4013 for, according to the registered service information with the service providers stored in the storage means, authenticating whether or not the message is sent by a service registered with the service providers stored in the message receiving device 401. In addition, according to a preferred embodiment, the message receiving device 401 further comprises first sending means 4015 for requesting information of the service registered with service providers by the message receiving device but not stored locally or the total information of services registered with the service providers by the message receiving device 401 and second receiving means 4016 for receiving the information of services registered with service providers by the message receiving device 401 but not stored locally or the total information of services registered with the service providers by the message receiving device and storing the received information into the storage means 4012. According to another preferred embodiment, the message receiving device 401 further comprises second sending means 4017 for sending the request for registering the service provided by the service provider and third receiving means for receiving acknowledgement of registering the service provided by the service provider. According to other embodiment of this invention, the message receiving device 401 further comprises third receiving means. At the same time of the third receiving devices receiving the acknowledgement of success of requesting for the service registered with the service provider, the second receiving means 4016 receives the information of services registered but not locally stored by the message receiving device 401 or the total information of services registered by the message receiving device 401. According to an additional embodiment of the invention, the message receiving device 401 further comprises third sending means (not shown in FIG. 4) for, in response to that the message is sent by the service registered with the service providers and stored in the message receiving device 401, accepting the message and sending an acknowledgement of receiving the message successfully.

The message sending device shown in FIG. 4 comprises first receiving means 4019 for receiving a service message sent by a service provider to a message receiving device 401; first sending means 4018 for sending the service message sent by a service provider to a message receiving device 401 to the message receiving device 401; and second sending means 4020 for sending the information of services registered with service providers by the message receiving device 401 to the message receiving device 401, wherein the information of services registered with service providers by the message receiving device 401 includes the information of services registered with service provider by the message receiving device 401 but not stored locally or the total information of services registered with service provider by the message receiving device 401.

In a preferred embodiment, the message sending device 402 further comprises second receiving means 4021 for receiving the information of services registered with the service providers by the message receiving device 401 but not stored locally or the total information of services registered with the service providers by the message receiving device 401; third receiving means 4023 for receiving a request for registering the service provided by a service provider from the message receiving device 401; recording means 4024 for storing the information of services registered with service provider by the message receiving device 401; third sending means 4022 for sending message of registering a service to the service provider by the message receiving device 401; and forth sending means which is not shown in FIG. 4 for sending an acknowledgement of success of registering service to the message receiving device 401.

By using the message sending device and the message receiving device shown in FIG. 4, the requirements can be satisfied for distributed authenticating the message which is sent by the service providers but not the registered service message with the service provider by the message receiving device 401. In addition, the message sending device 402 workload can be reduced greatly because this authentication process is carried out on the message receiving device 401, and thus there is neither the need to require a lot of servers to support centralized message authentication, nor the need to worry about the huge workload to the authentication server caused by too much message authentication work.

There is also provided a computer program product, comprising program code for implementing the method based as recited in one of method claims, the computer program product comprising a medium for storing the program code.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description but is not intended to exhaust or limit the invention in the form disclosed. Many modifications and variations will be apparent to those of ordinary skill in the art. The embodiments were chosen and described in order to best explain the principles of the invention and the practical application, and to enable others of ordinary skill in the art to understand the invention for various embodiments with various modifications as are suited to the particular use contemplated.

Although the illustrative embodiments have been described herein with reference to the accompanying drawings, it is to be understood that the present invention is not limited to those precise embodiments, and that various other changes and modifications may be affects therein by one of ordinary skill in the related are without departing from the scope or spirit of the invention. All such changes and modifications are intended to be included within the scope of the invention as described by the appended claims.

1. A message receiving device, comprising:
storage means for storing information of services registered by a message receiving device with a service provider from a message sending device;
first receiving means for receiving a message of service sent by the message sending device and provided by the service provider; and
authenticating means for, according to information of services registered with the service provider stored in the storage means, authenticating whether or not the message is sent by a service registered with the service provider stored in the storage means.

2. The message receiving device as recited in claim 1, further comprising:
first sending means for requesting for the information of services registered with service provider by the message receiving device but not stored locally or the total information of services registered with the service provider by the message receiving device;
second receiving means for receiving the information of services registered with a service provider by the message receiving device but not stored locally or the total information of services registered with the service provider by the message receiving device and storing the received information into the storage means; and
wherein the authentication means, based on the total information of services registered with the service provider stored in the storage means, authenticates whether or not the message of service is sent by a service registered with the service provider stored in the storage means, and wherein if the message is not sent by the service registered with the service provider stored in the message receiving device, the message is discarded.

3. The message receiving device as recited in claim 1, wherein if the message is not sent by the service registered with the service provider stored in the message receiving device, the message is discarded.

4. The message receiving device as recited in claim 2, further comprising:
second sending means for sending the request for registering the service provided by the service provider; and
third receiving means for receiving an acknowledgement of success of requesting for registering the service provided by the service provider.

5. The message receiving device as recited in claim 1, further comprising:
first sending means for sending the request for registering the service provided by the service provider;
second receiving means for receiving the information of services registered with the service provider but not stored locally or the total information of services registered with the service provider and storing the received information locally;
third receiving means for receiving an acknowledgement of success of requesting for registering the service provided by the service provider; and
wherein at the same time of the third receiving means receiving the acknowledgement of success of requesting for registering the service provided by the service provider, the second receiving means receives the information of services registered with the service provider but not stored locally or the total information of services registered with the service provider and storing the received information in the storage means.

6. The message receiving device as recited in claim 1, further comprising:
sending means for, in response to the message being sent by the service registered with the service provider stored in the message receiving device, accepting the message and sending an acknowledgement of success of receiving message.

7. A message sending device, comprising:
first receiving means for receiving a service message sent by a service provider to a message receiving device; and
first sending means for sending the service message to the message receiving device;
second sending means for sending the information of services registered with the service provider by the message receiving device to the message receiving device.

8. The message sending device as recited in claim 7, wherein the information of services registered with service provider by the message receiving device includes the information of services registered with the service provider by the message receiving device but not stored locally or the total information of services registered with service provider by the message receiving device.

9. The message sending device as recited in claim 7, further comprising:
second receiving means for receiving the information of services registered with the service provider by the message receiving device but not stored locally or the total information of services registered with the service provider by the message receiving device;
third receiving means for receiving a request for registering the service provided by a service provider from the message receiving device;
recording means for storing the information of services registered with service provider by the message receiving device;
third sending means for sending message of service registered with the service provider by the message receiving device; and
forth sending means for sending an acknowledgement of success of registering service to the message receiving device.

10. A computer implemented method of message receiving, the method comprising:
receiving a message of service sent by a message sending device and provided by a service provider; and
according to information of services registered with the service provider stored locally, authenticating whether or not the message is sent by service registered with the service provider stored locally.

11. The method as recited in claim 10, further comprising:
in response to the message being not sent by the service registered with the service provider stored locally, performing the following steps:
requesting for the information of services registered with the service provider but not stored locally or the total information of services registered with the service provider;
receiving the information of services registered with service provider but not stored locally or the total information of services registered with the service provider and storing the received information locally; and
wherein based on the total information of services registered with service provider stored locally, authenticating whether or not the message of service is sent by the service registered with the service provider and stored locally, and if the message is not sent by the service registered with the service provider and stored locally, the message is discarded.

12. The method as recited in claim 10, further comprising:
in response to the message being not sent by the service registered with the service provider and stored in the message receiving device, discarding the message.

13. The method as recited in claim 10, further comprising:
sending the request for registering the service provided by the service provider; and
receiving an acknowledgement of success of requesting for registering the service provided by the service provider.

14. The method as recited in claim 10, further comprising:
sending the request for registering the service provided by the service provider;
receiving an acknowledgement of success of requesting for registering the service provided by the service provider; and
receiving the information of services registered with the service provider but not stored locally or the total information of services registered with the service provider and storing the received information locally.

15. The method as recited in claim 10, further comprising:
in response to the message being sent by the service registered with the service provider and stored in the message receiving device, accepting the message; and
sending an acknowledgement of success of receiving the message.

16. A computer implemented message sending method, comprising:
receiving a message of service sent by a service provider to a message receiving device;
sending the message of service to the message receiving device; and
sending information of services registered with a service provider by the message receiving device to the message receiving device.

17. The method as recited in claim 16, wherein the information of services registered with the service provider by the message receiving device include the information of services registered with service provider by the message receiving device but not stored locally or the total information of services registered with service provider by the message receiving device

18. The method as recited in claim 16, further comprising:
receiving a request for registering the service provided by the service provider from the message receiving means;
recording the information of services registered with service provider by the message receiving device;
sending the message of service registered with the service provider by the message receiving device;
receiving the information of services registered with the service provider by the message receiving device but not stored locally or the total information of services registered with the service provider by the message receiving device; and
sending an acknowledgement of success of registering service to the message receiving device.

19. A computer program product comprising a storage type computer program readable medium including computer instructions, said computer instructions when loaded onto a computer memory perform a method of sending or receiving a message, said computer program readable medium comprising:
computer instructions for receiving a message of service sent by a message sending device and provided by a service provider;
computer instructions for according to information of services registered with the service provider stored locally, authenticating whether or not the message is sent by service registered with the service provider stored locally;
computer instructions for receiving the message of service sent by the service provider to a message receiving device;
computer instructions for sending the message of service to the message receiving device; and
computer instructions for sending information of services registered with the service provider by the message receiving device to the message receiving device.
